(19) United States
(12) Patent Application Publication
(10) Pub. No.: US 2013/0126543 A1
(43) Pub. Date: May 23, 2013

(54) SHEET WITH MULTIPLE THICKNESS AND METHODS FOR FORMING SAME

(71) Applicants: Timothy H. Bohrer, Chicago, IL (US); William J. Barenberg, Plano, TX (US)

(72) Inventors: Timothy H. Bohrer, Chicago, IL (US); William J. Barenberg, Plano, TX (US)

(21) Appl. No.: 13/681,817

(22) Filed: Nov. 20, 2012

Related U.S. Application Data
(60) Provisional application No. 61/562,595, filed on Nov. 22, 2011.

(51) Int. Cl. B65D 43/16; B29C 47/88; B29C 43/46; B29C 43/24

(52) U.S. Cl. CPC B65D 43/162; B29C 43/24; B29C 47/8845; B29C 43/46
USPC 220/810; 264/175; 425/224; 425/378.1; 428/156

(57) ABSTRACT

A method of forming thermoforming sheets includes providing a molten polymer source. The method further includes providing a first and second roller, the second roller having a first and second section, the first section having a first diameter and the second section having a second diameter. The method further includes feeding molten polymer from the molten polymer source into a nip between the first and second roller. The method further includes forming the thermoforming sheets having a first and second portion, the first portion corresponding to the first and second section of the second roller respectively, the first portion have a first thickness corresponding to the first diameter and the second portion having a second thickness corresponding to the second diameter.

### RELATED APPLICATIONS

This application claims the benefit of U.S. Provisional Patent Application Ser. No. 61/562,595 filed Nov. 22, 2011 which application is hereby incorporated by reference.

### BACKGROUND

One-piece plastic lidded containers comprising a product containing portion and an integral lid or closure portion, which are connected to each other by an integral hinge area, offer users substantial advantages compared to two-piece lidded containers that use separate trays and matching lids. Separate lids can easily be misplaced, require separate storage and are operationally more complex for users of packaging, whether in food service, retail or other product packing environments. It is also much more convenient for consumers to use one-piece lidded containers, especially when the container holds a product that the consumer may access multiple times, requiring several openings and closings of the container. Alignment for reclosure is simplified and lids are always immediately available with one-piece lidded containers.

One persistent drawback of one-piece containers, however, is associated with cost effectiveness compared to two-piece systems. The individual components that are used together to assemble two-piece lidded containers can easily be made from plastic sheet material of different thicknesses, allowing both components to be made from the lowest sheet thickness that results in satisfactory performance. Two-piece lidded containers can thus easily be optimized for lowest total weight of plastic material used and therefore are very cost effective in terms of the weight of material used.

In contrast, one-piece thermoformed containers have historically been produced from thermoforming sheets of uniform thickness, which imposes the requirement that the product containing and closure or lid portions must be made from the same thickness starting material. The starting thickness chosen is that which is required to provide satisfactory properties of the formed container portion. This is typically the containing portion, which is made deeper to provide product holding volume, requiring greater forming displacement and stretching of softened plastic material out of the plane of the original plastic sheet. This results in more plastic material in the closure or lid portion than is required for meeting minimum performance requirements.

For cost as well as for environmental sustainability reasons, this is undesirable and represents excess material use. This problem is exacerbated as the end use requires increasing depth of the finished product containing portion, as the thinning that takes place during forming this containing portion increases with increasing depth and requires greater and greater original plastic sheet thickness to produce satisfactorily performing finished containers.

As an example, it is not unusual for a two-piece lidded container to be made from thermoforming sheet of 0.040 to 0.050 inches, in which the closure or lid portion is made from 0.015 to 0.020 inches. The degree of material overuse increases as the depth of the bottom container increases. The thickness of the material for the bottom portion of the container or containing portion is determined by depth required for the containing portion as compared to a characteristic planar dimension of a line connecting two points of opposite sides of the perimeter of the top or open end of the containing portion.

It would be a significant improvement over historical practice if it were possible to easily produce one-piece lidded containers in which the product containing portions and closure or lid portions were produced from thermoforming sheet thicknesses optimized for performance at minimum required thickness. Previous attempts to solve this problem have included a technique described in U.S. Pat. No. 6,805,659 (inventor Timothy Bohrer and assigned at issuance to Ivex Packaging Corp.). The '659 patent discloses a method in which lengths of thermoplastic material having different characteristics (color, thickness, chemical composition, etc.) are brought in to overlapping or abutting orientation to provide junctions that can be subsequently secured. Proper orientation of the rolls of such secured materials can then be formed to make one-piece lidded packages that utilize materials of different characteristics, including thickness, for product containing and closure or lid portions.

This attempted solution, however, has operational drawbacks and while disclosed is flawed. Foremost among the difficulties is finding suitable material securing methods that can operate at high speed to provide consistently strong bonds; also, any side-to-side weaving of any of the lengths of thermoplastic materials results in changes in dimensions of the overlap areas and puts satisfactory performance of the formed container at risk. Finally, while it may be desirable to undertake the securing of the individual lengths of thermoplastic material as part of the thermoforming operation; this imposes an additional degree of process complexity on the thermoforming company. Such companies are continually working to simplify their processes and would be expected to resist this more complex technology. Thus, there still remains a need to supply thermoforming operations with plastic sheet which can be simply formed into one-piece lidded containers having different thicknesses in the areas to be made into product containing and closure or lid portions.

### SUMMARY

In one embodiment, a method of forming thermoforming sheets includes providing a molten polymer source. The method further includes providing a first and second roller, the second roller having a first and second section, the first section having a first diameter and the second section having a second diameter. The method further includes feeding molten polymer from the molten polymer source into a nip between the first and second roller. The method further includes forming the thermoforming sheets having a first and second portion, the first and second portions corresponding to the first and second section of the second roller respectively, the first portion having a first thickness corresponding to the first diameter and the second portion having a second thickness corresponding to the second diameter. Throughout the disclosure, emphasis is given to thermoforming sheets however, non-thermoforming sheets or objects are equally contemplated, such as those objects merely formed from thermoplastic and shaped and then not further thermoformed. Optionally, the method further includes providing a heat input prior to the feeding such that the first and second thickness are changed as compared to providing no heat input. In one alternative, a heat input is applied to a first area, the first area in-line with the first section of the roller and not extending to an area in-line with the second section of the roller. Alternatively, the first and second portions correspond to a first and second area of a container to be formed. Optionally, the first area is a container portion and the second area is a lid portion. In one alternative, the method includes thermoforming the container from the thermoforming sheets, the container having the container portion and the lid portion. Optionally, the thermoforming sheets are polymeric.

In one embodiment, a system for forming polymer sheets includes a sheet forming machine, the sheet forming machine providing molten polymer. The system also includes an extrusion die and also a chill roll, the chill roll receiving the molten polymer from the extrusion die of the sheet forming machine, the extrusion die including die lands and lips, the die lands and lips providing for first and second formation areas, the first and second formation areas providing a sheet on the chill roll having a first area or areas having a first thickness and a second area or areas having a second thickness. Optionally, the die lands and/or lips are removable and a second set of die lands and/or lips replace the first die lands and/or lips, the second set resulting in a different thickness for the first and second area or areas.

In one embodiment, a container includes a single piece of a thermoforming sheet, the thermoforming sheet having first and second areas, the first area or areas having a first thickness, the second area or areas having a second thickness, the single piece having a hinge and the first area or areas being formed into a container portion or portions and the second area or areas being formed into a lid portion or portions. Optionally, third and a fourth areas having a third and fourth thickness respectively are included. Alternatively, the thermoforming sheet is a single sheet of material form from a single extrusion from a die.

In one embodiment, a system for forming thermoforming sheets includes a molten polymer source and a first roller. The system further includes a second roller, positioned to form a nip between the first and second roller, the second roller having a first and second section, the first section having a first diameter and the second section having a second diameter, the molten polymer source positioned to provide molten polymer to the nip. Optionally, the second roller includes a sleeve, the sleeve providing for the second diameter, the sleeve detachably integrated into the second roller. Alternatively, the first roller has a first and second section, the first and second section of the first roller having a first and second diameter.

In one embodiment, a roller and sleeve system for use with a system for forming thermoforming sheets, the roller and sleeve system includes a first roller and a second roller. The system further includes plurality of sleeves, each sleeve of the plurality having a first inner diameter, the first inner diameter corresponding to an outer diameter of the second roller, each sleeve of the plurality having a second outer diameter, the second outer diameter being different for each sleeve, wherein the first roller and the second roller are positionable in the system for forming thermoforming sheets such that a first nip and a second nip are created, the first nip creating a first distance between an outer surface of the first roller and the outer surface of the second roller and the second nip creating a second distance between an outer surface of the first roller and an outer surface of a sleeve of the plurality of sleeves positioned on the second roller.

In one embodiment, a roller and sleeve system for use with a system for forming thermoforming sheets, the roller and sleeve system includes a first roller and a second roller. The system further includes a plurality of sleeves, each sleeve of the plurality having a first inner diameter, the first inner diameter corresponding to an outer diameter of the first or second roller, each sleeve of the plurality having a second outer diameter, the second outer diameter being different for each sleeve, wherein the first roller and the second roller are positionable in the system for forming thermoforming sheets such that a first nip and a second nip are created, the first nip creating a first distance between an outer surface of a first roller sleeve combination and an outer surface of a second roller sleeve combination, the second nip creating a second distance between an outer surface of a third roller sleeve combination and an outer surface of a fourth roller sleeve combination, wherein the first roller sleeve combination is selected from the group consisting of the first roller and the first roller with any sleeve of the plurality of sleeves, the second roller sleeve combination is selected from the group consisting of the second roller and the second roller with any sleeve of the plurality of sleeves, the third roller sleeve combination is selected from the group consisting of the first roller and the first roller with any sleeve of the plurality of sleeves, and the fourth roller sleeve combination is selected from the group consisting of the second roller and the second roller with any sleeve of the plurality of sleeves.

In another embodiment, a roller for using in forming thermoplastic sheets includes a first roller piece having a first diameter. The roller also includes a sleeve, configured to engage the first roller piece, the sleeve having a second diameter greater than the first diameter, the sleeve configured to hold firmly to the first roller piece.

In another embodiment, a roller and sleeve system for use with a system for forming thermoforming sheets includes a first roller and a second roller. The system further includes a diameter increasing material, the diameter increasing material applied to the second roller to create an area of increased diameter, wherein the first roller and the second roller are positionable in the system for forming thermoforming sheets such that a first nip and a second nip are created, the first nip creating a first distance between an outer surface of the first roller and the outer surface of the second roller and the second nip creating a second distance between an outer surface of the first roller and the area of increased diameter on the second roller. Optionally, the diameter increasing material is non-metallic. Alternatively, the diameter increasing material has suitable temperature resistance, dimensional and mechanical stability and polymer release properties for use in forming thermoforming sheets. Optionally, the diameter increasing material is self-adhesive polytetrafluoroethylene tape. Alternatively, the diameter increasing material is a crosslinked polymer.

In one embodiment, a thermoforming sheet includes a first area having a first thickness and a second area having a second thickness, wherein the thermoforming sheet is extruded as a single piece of material. Optionally, the sheet is not formed from joining multiple sheets of different thicknesses. Alternatively, the thermoforming sheet is configured to be formed into a container, the first area corresponding to a receptacle portion of the container and the second area corresponding to a lid portion of the container. In one alternative, the thermoforming sheet is configured to be formed into an object, the first area corresponding to a first area of the object and the second area corresponding to a second area of the object, the thermoforming sheet being further heated and shaped to form the object. In another alternative, the first thickness is greater than the second thickness. Optionally, a first and second roller are used to form the thermoforming sheet, at least one of the first and second roller having an area of increased thickness, the area of increased thickness configured to create the second area, the second thickness being less that the first thickness.

In one embodiment, thermoplastic sheet includes a first area having a first thickness and a second area having a second thickness, wherein the thermoplastic sheet is extruded as a single piece of material. As with all of the embodiments and alternatives described herein, the sheets referred to need not be thermoforming and instead may be merely thermoplastic. In one alternative, the sheet is not formed from joining multiple sheets of different thicknesses.

### BRIEF DESCRIPTION OF THE DRAWINGS

FIG. 1 shows one embodiment of a perspective view of such a container form from a sheet with multiple thicknesses;

FIG. 2 shows a cross section of the container of FIG. 1;

FIGS. 3a-b show cross-sections of various embodiments of sheets with multiple thicknesses;

FIG. 4 shows a cross-sections of an embodiments of sheets with multiple thicknesses;

FIG. 5 shows a perspective view of an embodiment of sheets with multiple thicknesses; and

FIG. 6 shows an embodiment of a roller configuration.

### DETAILED DESCRIPTION

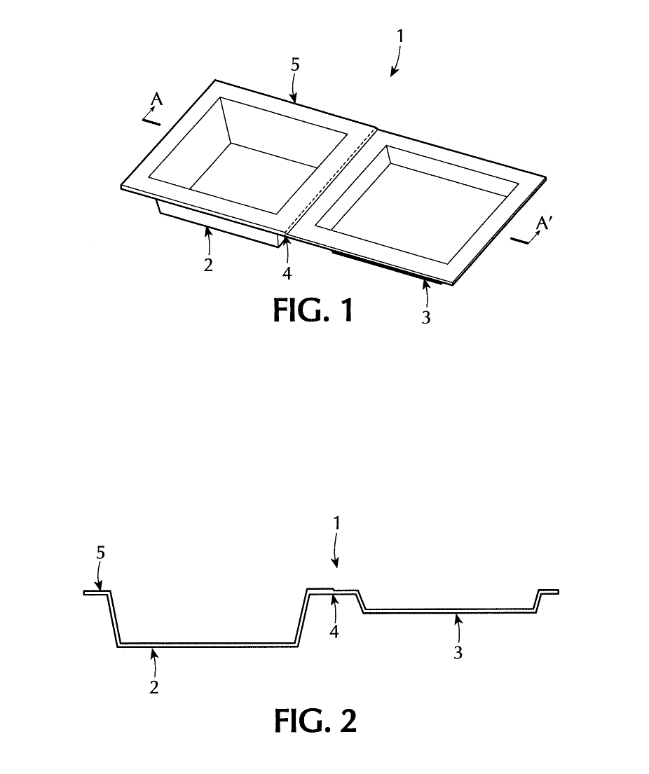

The sheet with multiple thicknesses (“SMT”) and methods and systems for forming the same are based on the concept of incorporating regions of different thickness of plastic during the thermoforming sheet forming operation and using those sheets to make one-piece lidded containers with the amount of material in the product containing portions and the closure or lid portions optimized for minimum weight and thickness to achieve desired performance. The sheet, method of forming such a sheet and containers made from such sheets are all considered elements of this disclosure. A perspective drawing of such a container is shown in FIG. 1. In this figure, the one-piece lidded container 1 comprised of product containing portion 2 (referred to elsewhere as a receptacle portion or a container portion) is connected to closure or lid portion 3. Both portions 2 and 3 have flange areas 5 which may include opening, tamper-evident, resealing or other features which are not included for simplicity. In FIG. 1 these are shown as continuous and of similar dimensions for portions 2 and 3, but other arrangements are also possible and within the scope of this disclosure. The area 4 between the two portions connects the two, creating the one-piece nature of the container and will generally include a hinge area so the closure or lid portion can rotate around that hinge line and the flange areas 5 of the two portions may be brought into contact to achieve closure. Many types of hinge arrangements will be apparent to those skilled in the art in light of this disclosure and are within the scope of inclusion in this disclosure.

FIG. 2 is a cross section through line A-A′ of FIG. 1 and shows schematically that the material used to form product containing portion 2 is thicker than that used to form closure or lid portion 3. Thickness of material to form both pieces has been exaggerated for clarity.

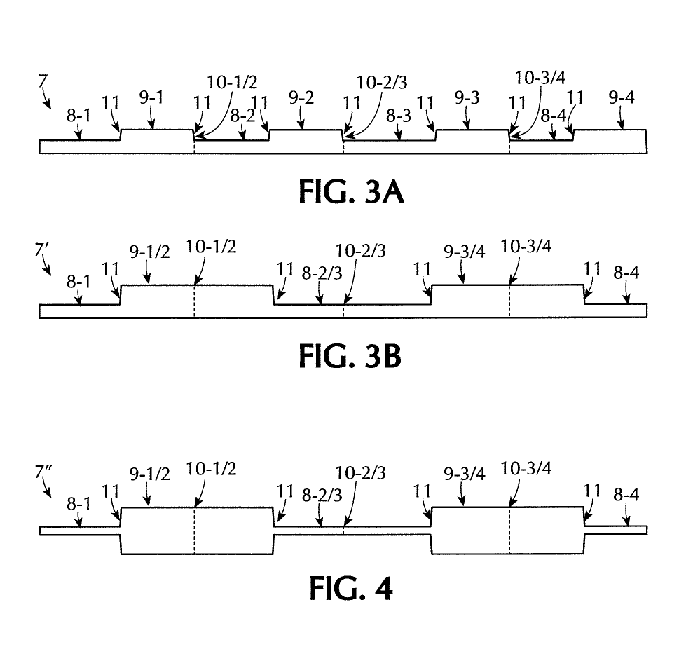

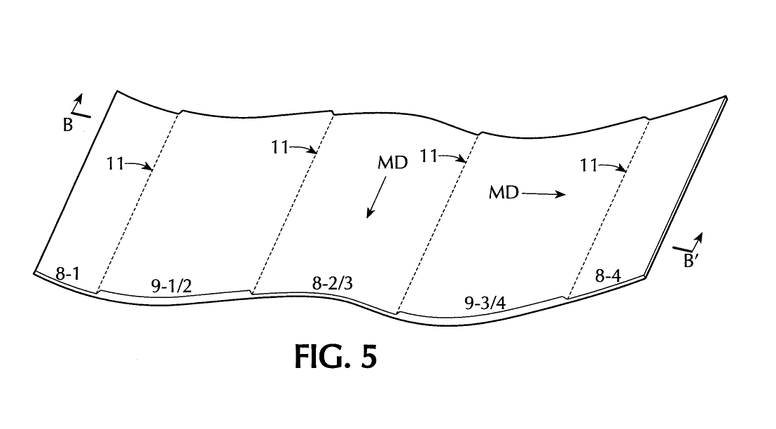

The rolls of plastic thermoforming sheet thus formed will include lengthwise segments of differing thickness. FIG. 5 provides a perspective view of such a sheet. If one were to cut a cross section of such a sheet across the lengthwise (or machine) direction (shown in FIG. 5 as MD) of travel, a transverse (or cross-machine) (TD in FIG. 5) direction profile of different thicknesses would be evident, such as shown in FIGS. 3a, 3b and 4, with FIG. 3b representing the cross section B-B′ of FIG. 5. The thicker areas 9-x (e.g. areas 9-1, 9-2, 9-3 and 9-4) or 9-x/y (e.g. areas 9-1/2 and 9-3/4) are intended to be formed into the product containing portion of the one-piece lidded container while the thinner areas 8-x (e.g. areas 8-1, 8-2, 8-3, and 8-4) or 8-x/y (e.g. areas 8-1/2 and 8-3/4) are intended to be formed in the closure or lid portion of the container. The width and number of thin and thick areas can vary depending on the dimensions of the final package as well as the width capabilities of the thermoforming machine on which the containers will be produced.

In FIG. 3a, the nomenclature for the thin and thick areas, 8-x (8-1, 8-2, 8-3, 8-4) and 9-x (9-1, 9-2, 9-3, 9-4), respectively identifies the one-piece lidded container that will be formed from that portion of sheet 7. For example, 8-1 and 9-1 identify the thin and thick areas and thus the closure/lid portion 3 and product containing portion 2 of a single container #1. FIGS. 3b and 4 include areas such as 9-1/2 where a single thin or thick area of the sheet ultimately is divided between two containers, in the case of 9-1/2, containers 1 and 2. These Figures represent some of the different arrangements possible for thin and thick areas. These particular sheet cross sections comprise thin and thick areas that will result in four MD lanes of discrete one-piece lidded containers; obviously other numbers of containers may be arranged in the TD of the plastic roll stock, depending on the dimensions of the container and the size of the thermoforming machine on which they will be formed. Dotted lines 10-x/y (10-1/2, 10-2/3, 10-3/4) identify where containers adjacent to each other will be cut apart from each other during or after forming to yield discrete containers; 10-1/2 identifies the separation line between containers 1 and 2. For clarity these are shown as a line of separation, but in practice could be non-zero width (in the TD) areas of trim between containers. Transition areas 11 between thin areas 8-x or 8-x/y and thick areas 9-x or 9x/y represent the TD distance over which the transition between the two different thicknesses occur; this TD distance may be varied for a variety of sheet and container production considerations.

Typically those who produce thermoforming sheet attempt to provide as uniform thickness as possible, as sheets offering less variation in thickness in both the machine and cross-machine directions in a roll of plastic material are well known by those skilled in the art to result in higher quality finished containers and container components, and offer the opportunity to reduce overall target thickness of the sheet, reducing the material required to make satisfactorily performing containers. It is thus counterintuitive to deliberately create zones of differing thicknesses during the thermoforming sheet manufacturing process.

The thermoforming sheet manufacturing process involves delivery of molten plastic from a generally rectangular, but thin, die slot onto a rotating roller or into a nip formed by two counter rotating rollers. Such rollers, as is widely known in the art, are temperature controlled in such as way as to allow the molten polymer to extend in the direction of machine travel (and roll rotation) to the desired finished thickness and then to freeze or solidify the polymer at that thickness. The remainder of the sheet manufacturing product machine further cools the now solid sheet, trims material from the longitudinal edges of the sheet that are not readily usable, and winds the solidified and trimmed moving web of plastic sheet material into rolls that are readily amenable to shipping and are easily unwound for container forming on the thermoforming machine.

Since containers are produced in mass, generally in multiple separate product orders, and the thermoforming molds for containers are commonly reused, the position of containers or receptacles and their lids and dividers can be planned. Therefore, the sheets can be formed with the proper thicknesses corresponding to the lids and container or receptacle areas. Therefore, a plurality of sheet types having preset thicknesses may be made corresponding to a plurality of predetermined container types.

There are several means possible to create the sheets of multiple thicknesses, sheets that contain lengthwise areas of different thickness. In the case of a sheet forming machine that delivers the molten polymer to a single rotating roller (often called the ‘chill roll’ process in the art), the opening of the die slot may be varied by using sets of opposing specially designed die lands and lips, which are the portions of the sheet forming die that are last to contact the moving molten polymer stream, and the dimensions of which are critical in forming the desired thickness profile of the molten polymer prior to its contact with the rotating roller. In this case, instead of controlling the die land and lip geometry to create a highly uniform final transverse direction thickness profile, the geometry is controlled to create zones with significantly different thicknesses, which after the typical thinning that occurs between the molten polymer exiting the die lands and lips and solidifying on the rotating roller, results in the desired thickness in the designed zones. The cross sections of thermoforming sheet in FIGS. 3a, 3b and 4 also are representative of possible TD cross sections of the molten polymer as it exits the die lips and will also correspond closely to TD cross sections of the opening between opposing die lands and lips used to produce the respective sheets.

For the single roller sheet manufacturing approach sets of specially designed die lands and lips and other molten polymer flow modifying inserts or components internal to the extrusion die that may facilitate achieving desired flow distribution are preferably designed and fabricated, with each set corresponding to the zone dimensions (width and thickness) required to produce the thermoforming sheet for a specific one-piece lidded container. One skilled in the art of die design and manufacture for use in thermoforming sheet producing machines would also understand in light of this disclosure, that quick change mechanisms that allow rapid switching between sets of die lands and lips and other useful die inserts or components are desirable to minimize change over time and cost as well as lost material during such changes.

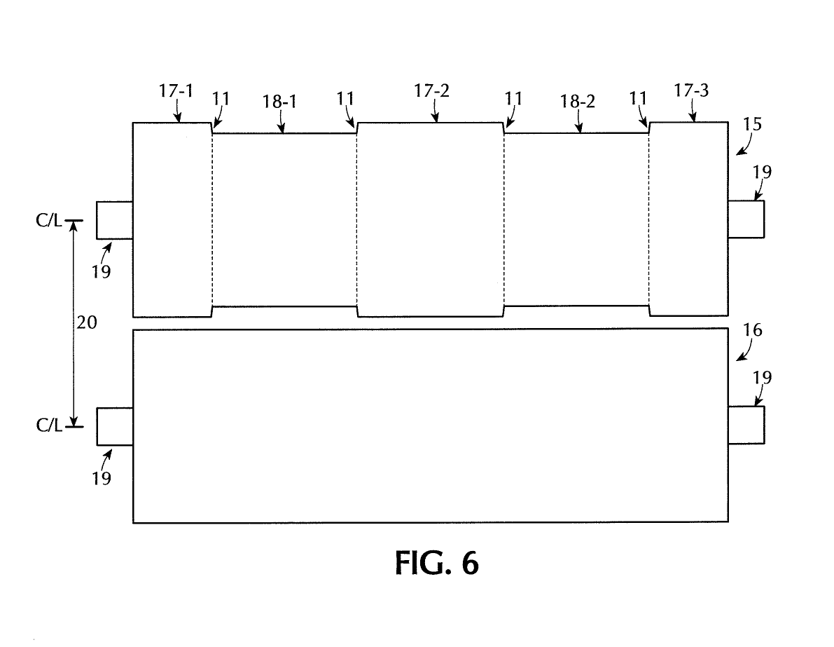

When utilizing the sheet forming technique in which the thickness of the molten polymer is determined principally by the gap between two counter-rotating rollers, (a technique often referred to in the art as ‘calendaring’), a means to create the desired transverse direction zones of differing thickness comprises contouring the surface of one or both of the rollers to very slightly change the diameter of the roll in one circumferential area or set of such areas compared to another circumferential area or set of such areas. This contouring serves to create different gaps between the surfaces of the two rollers, allowing different amounts of the molten polymer to pass through different radially sized gaps and yielding different thicknesses across the transverse direction of the solid plastic thermoforming sheet. The sheet TD profile shown in FIG. 3b would result from a calendaring rollers arrangement similar to that shown in FIG. 6. Rollers 15 and 16 are supported and driven by shaft ends 19. Roller 16 represents a traditional roller used to make traditional sheet of consistent TD thickness profile and has a smooth, virtually linear TD surface. The surface of Roller 15, however, has been machined with contours that define areas where more or less polymer is deliberately allowed to flow between the surfaces of rollers 15 and 16, yielding sheet with areas of different thickness. The surface contours of roller 15 and thus the gap dimensions between the surfaces of rollers 15 and 16 in FIG. 6 are exaggerated for clarity. Greater diameter areas 17-x (17-1, 17-2, 17-3) and lesser diameter areas 18-x (18-1, 18-2, 18-3) on roller 15 as well as areas 11 correspond, respectively to thinner sheet areas 8-x (and 8-x/y), thicker sheet areas 9-x (and 9-x/y) and transition areas 11 of the sheet of FIG. 3b. To create the sheet 7″ of FIG. 4, two matched contoured rollers machined similar to roller 15 of FIG. 6 would be employed. Sheets with symmetry in the thickness direction, such as that shown in FIG. 4 or without such symmetry such as in FIGS. 3a and 3b are within the scope of this disclosure and may be useful to produce different packages. It is also within the scope to envision sheets that are variations on FIG. 4 that are not symmetrical in the thickness direction.

One skilled in the art will realize that by adjusting the distance 20 between the centerlines of the two rollers, one can also adjust on a relative basis the gap between their surfaces and thus the thickness differences between zones in the final sheet. There is little that can be done to change the transverse direction width of the zones or their relationship to each other, but within a range, changing the distance between the centerlines of the two rollers affords some adjustment to the thickness of the final sheet in the zones. This of course comes with the understanding that increasing the centerline distances will generally result in all zones becoming thicker and conversely, decreasing the centerline distances will generally result in all zones becoming thinner, but the relationship of the increase and decrease of those zones will also depend to a certain extent in the flow rate, viscosity, relaxation and other flow characteristics of the polymer, which are dependent on temperature, polymer structure and the flow history the polymer has experienced among other variables.

One skilled in the art will understand that providing differential heat input to the melt prior to it contacting the rollers may also serve to provide some thickness adjustment and can be used to fine tune relative thicknesses between zones and extend the range of utilization of a given set of rollers beyond just what can be achieved through adjusting gaps. This heat input can, for example, occur in the die land/lip area or outside of the die before contact with rollers.

The most straightforward way to create the transverse diameter profile of one or both rollers is to machine these diameter profiles into the roller(s) during manufacture. Roll machining is a process fully capable of creating such profiles, which can be adjusted to take into account subsequent plating or otherwise mechanically or chemically treating the roller surfaces for hardness, chemical resistance, smoothness, etc. For large, repeat orders for one-piece lidded containers of the same general length and width dimensions, the investment in a special set of such rollers can be justified easily based on the savings in polymer usage and the desirability of a lower environmental profile through such weight reduction.

For smaller orders, or more frequent changes in length and width dimensions, it may be more desirable to create less costly quick change sleeves that fit tightly in good heat transfer and contact relationship on infrequently changed rollers that essentially become mounting rollers. In this embodiment, the thin (relative to the diameter of the mounting rollers) wall sleeves are easily removed and new sleeves installed to yield a new set of zone widths and depths. Sleeves may be machined from thin wall cylinders of metal, which are subsequently coated or otherwise treated as described above. In another related approach, instead of a single contoured surface sleeve mounted on a mounting roller, one may create the same result by using multiple thin wall cylindrical sleeves that are arranged adjacent to each other longitudinally on the mounting rollers, each of the multiple cylindrical sleeves potentially corresponding to either thin or thick areas, or both thin and thick areas corresponding to single finished containers. In this latter approach, the points at which two adjacent thin wall cylinders meet can be adjusted so as to fall into areas of trim or scrap on the thermoforming machine, if so desired. Other useful arrangements of multiple cylindrical sleeves will be evident to one skilled in the art in light of this disclosure.

While less desirable in terms of finished package surface defects, one can also create roller sleeves that are segmented circumferentially; this approach can simplify removal and mounting of different designs of zones and thicknesses, or both thin and thick areas corresponding to single finished containers. Other mounting techniques fall within the scope of this disclosure.

It is also contemplated to create different diameters in desired segments of a roller or set of rollers by increasing the diameter where desired by adding easily applied or shaped, preferably nonmetallic materials with suitable temperature resistance, dimensional and mechanical stability and polymer release properties. Such materials could provide a less costly approach to creating different diameters, although at some potential loss of useful life. Such additions would be useful in quickly creating prototype containers or useful products or for very small production runs. In one example self-adhesive polytetrafluoroethylene tape is used to build up areas of a roller surface to greater diameter. Other approaches including crosslinking polymers that can easily be removed after use are within the scope of this disclosure.

It will be understood that there may be different patterns to transition areas 11 between adjacent zones of differing thickness, depending on the polymer, package design, thermoforming die design or other parameters. The nature of transitions may be determined as one of the variables of implementation, and this disclosure is not limited to specific thickness transition patterns. Multiple transition zone 11 patterns can be utilized in a single thermoforming sheet construction.

It will also be understood that while the focus of this disclosure is on one-piece lidded containers, other thermoformed (or otherwise fabricated from sheet or roll stock) plastic products can be envisioned for which it is desirable and useful for there to be zones of two or more distinct thickness separated by generally straight line lengths of transition between the different zones. Such products also fall within the scope of the disclosure and are implied by the term ‘one-piece lidded container’.

It will also be understood that while this disclosure focuses on containers where two different thicknesses are utilized, containers can be envisioned in which it is desirable and useful for there to be more than two different thicknesses incorporated into the container. Additional connected panels or separators are exemplary, but not limiting examples of such containers. All fall within the scope of this disclosure. The embodiments described above and shown herein are illustrative and not restrictive. The scope of the SMT and associated systems and methods is indicated by the claims rather than by the foregoing description and attached drawings. The SMT and associated systems and methods may be embodied in other specific forms without departing from the spirit of the SMT and associated systems and methods described. Accordingly, these and any other changes which come within the scope of the claims are intended to be embraced therein. In many cases the claims describe the thermoforming sheets in relation to a first area having a first thickness and a second area having a second thickness. In alternatives, more than 2 thicknesses may be included, for instance, a third area with a third thickness may be included and a fourth area having a fourth thickness may be included, etc. Whatever configuration of thicknesses that are configured to be formed into the applicable product may be used. Throughout the disclosure, emphasis is given to thermoforming sheets however, non-thermoforming sheets or objects are equally contemplated, such as those objects merely formed from thermoplastic and shaped and then not further thermoformed.

What we claim is:

1. A method of forming thermoforming sheets, the method comprising:
a) providing a molten polymer source;
b) providing a first and second roller, the second roller having a first and second section, the first section having a first diameter and the second section having a second diameter;
c) feeding molten polymer from the molten polymer source into a nip between the first and second roller;
d) forming the thermoforming sheets having a first and second portion, the first portion corresponding to the first and second section of the second roller respectively, the first portion have a first thickness corresponding to the first diameter and the second portion having a second thickness corresponding to the second diameter.

2. The method of claim 1, further comprising: providing a heat input prior to the feeding of (c) such that the first and second thickness are changed as compared to providing no heat input.

3. The method of claim 1, wherein a heat input applied to a first area, the first area in-line with the first section of the roller and not extending to an area in-line with the second section of the roller.

4. The method of claim 1, wherein the first and second portion correspond to a first and second area of a container to be formed.

5. The method of claim 4, wherein the first area is a container portion and the second area is a lid portion.

6. The method of claim 5, further comprising:
thermoforming the container from the thermoforming sheets, the container having the container portion and the lid portion.

7. The method of claim 1, wherein the thermoforming sheets are polymeric.

8. A system for forming polymer sheets, comprising:
a sheet forming machine, the sheet forming machine providing molten polymer;
the sheet forming machine further comprising an extrusion die and a chill roll, the chill roll receiving the molten polymer from the die of the sheet forming machine, the die including die lands and lips, the die lands and lips providing for a first and second formation area, the first and second formation area providing a sheet having a first area having a first thickness and a second area having a second thickness.

9. The system of claim 8, wherein the die lands and lips are removable.

10. The system of claim 9, wherein a second set of die lands and lips replace the die lands and lips, the second set resulting in a different thickness for the first and second area.

11. A container, comprising:
a single piece of a thermoforming sheet, the thermoforming sheet having a first and second area, the first area having a first thickness, the second area having a second thickness, the single piece having a hinge and the first area being formed into a container portion and the second area being formed into a lid.

12. The container of claim 10, further comprising, a third and a fourth area having a third and fourth thickness respectively.

13. The container of claim 10, wherein the thermoforming sheet is a single sheet of material form from a single extrusion from a die.

14. A system for forming thermoforming sheets, comprising:
a) a molten polymer source;
b) a first roller;
c) a second roller, positioned to form a nip between the first and second roller, the second roller having a first and second section, the first section having a first diameter and the second section having a second diameter, the molten polymer source positioned to provide molten polymer to the nip.

15. The system of claim 14, wherein the second roller includes a sleeve, the sleeve providing for the second diameter, the sleeve detachably integrated into the second roller.

16. The system of claim 14, wherein the first roller has a first and second section, the first and second section of the first roller having a first and second diameter.

17. A roller and sleeve system for use with a system for forming thermoforming sheets, the roller and sleeve system comprising:
a first roller;
a second roller;
a plurality of sleeves, each sleeve of the plurality having a first inner diameter, the first inner diameter corresponding to an outer diameter of the second roller, each sleeve of the plurality having a second outer diameter, the second outer diameter being different for each sleeve, wherein the first roller and the second roller are positionable in the system for forming thermoforming sheets such that a first nip and a second nip are created, the first nip creating a first distance between an outer surface of the first roller and the outer surface of the second roller and the second nip creating a second distance between an outer surface of the first roller and an outer surface of a sleeve of the plurality of sleeves positioned on the second roller.

18. A roller and sleeve system for use with a system for forming thermoforming sheets, the roller and sleeve system comprising:
a first roller;
a second roller;
a plurality of sleeves, each sleeve of the plurality having a first inner diameter, the first inner diameter corresponding to an outer diameter of either the first or second roller, each sleeve of the plurality having a second outer diameter, the second outer diameter being different for each sleeve, wherein the first roller and the second roller are positionable in the system for forming thermoforming sheets such that a first nip and a second nip are created, the first nip creating a first distance between an outer surface of a first roller sleeve combination and an outer surface of a second roller sleeve combination, the second nip creating a second distance between an outer surface of a third roller sleeve combination and an outer surface of a fourth roller sleeve combination, wherein the first roller sleeve combination is selected from the group consisting of the first roller and the first roller with any sleeve of the plurality of sleeves, the second roller sleeve combination is selected from the group consisting of the second roller and the second roller with any sleeve of the plurality of sleeves, the third roller sleeve combination is selected from the group consisting of the first roller and the first roller with any sleeve of the plurality of sleeves, and the fourth roller sleeve combination is selected from the group consisting of the second roller and the second roller with any sleeve of the plurality of sleeves.

19. A roller for using in forming thermoplastic sheets, the roller comprising:
a first roller piece having a first diameter;
a sleeve, configured to engage the first roller piece, the sleeve having a second diameter greater than the first diameter, the sleeve configured to hold firmly to the first roller piece.

20. A roller and sleeve system for use with a system for forming thermoforming sheets, the roller and sleeve system comprising:
a first roller;
a second roller;
a diameter increasing material, the diameter increasing material applied to the second roller to create an area of increased diameter, wherein the first roller and the second roller are positionable in the system for forming thermoforming sheets such that a first nip and a second nip are created, the first nip creating a first distance between an outer surface of the first roller and the outer surface of the second roller and the second nip creating a second distance between an outer surface of the first roller and the area of increased diameter on the second roller.

21. The system of claim 20, wherein the diameter increasing material is non-metallic.

22. The system of claim 20, wherein the diameter increasing material has suitable temperature resistance, dimensional and mechanical stability and polymer release properties for use in forming thermoforming sheets.

23. The system of claim 20, wherein the diameter increasing material is self-adhesive polytetrafluoroethylene tape.

23. The system of claim 20, wherein the diameter increasing material is a crosslinked polymer.

24. A thermoforming sheet comprising:
a first area having a first thickness; and
a second area having a second thickness, wherein the thermoforming sheet is extruded as a single piece of material.

25. The thermoforming sheet of claim 24, wherein the sheet is not formed from joining multiple sheets of different thicknesses.

26. The thermoforming sheet of claim 24, wherein the thermoforming sheet is configured to be formed into a container, the first area corresponding to a receptacle portion of the container and the second area corresponding to a lid portion of the container.

27. The thermoforming sheet of claim 24, wherein the thermoforming sheet is configured to be formed into an object, the first area corresponding to a first area of the object and the second area corresponding to a second area of the object, the thermoforming sheet being further heated and shaped to form the object.

28. The thermoforming sheet of claim 26, wherein the first thickness is greater than the second thickness.

29. The thermoforming sheet of claim 24, wherein a first and second roller are used to form the thermoforming sheet, at least one of the first and second roller having an area of increased thickness, the area of increased thickness configured to create the second area, the second thickness being less that the first thickness.

30. A thermoplastic sheet comprising:
a first area having a first thickness; and
a second area having a second thickness, wherein the thermoplastic sheet is extruded as a single piece of material.

31. The thermoplastic sheet of claim 30, wherein the sheet is not formed from joining multiple sheets of different thicknesses.

32. The thermoplastic sheet of claim 30, wherein the thermoplastic sheet is configured to be formed into an object, the first area corresponding to a first area of the object and the second area corresponding to a second area of the object, the thermoplastic sheet being shaped to form the object.
